(19) United States
(12) Patent Application Publication
(10) Pub. No.: US 2016/0124099 A1
(43) Pub. Date: May 5, 2016

(54) METHOD AND SYSTEM FOR IDENTIFICATION OF GEOLOGY LITHOLOGICAL DIFFERENCE

(71) Applicant: PetroChina Company Limited, Beijing (CN)

(72) Inventors: Meng LI, Beijing (CN); Xiaodong ZHENG, Beijing (CN); Yan ZHANG, Beijing (CN); Jinsong LI, Beijing (CN)

(21) Appl. No.: 14/934,033

(22) Filed: Nov. 5, 2015

(30) Foreign Application Priority Data
Nov. 5, 2014 (CN) 201410616794.4

(51) Int. Cl. G01V 1/30

(52) U.S. Cl. CPC G01V 1/306

(57) ABSTRACT

The present invention relates to a method for identification of geology lithological difference which includes: obtaining seismic amplitude data of a geology object to be detected; using a seismic amplitude value of each grid point as the initial value of chaos nonlinear iteration equation and then to iterate by the equation, and recording an iteration convergence rate of each grid point when the iteration reaches a stable state; and depicting the lithological difference of the geology object to be detected by the difference of the convergence rate of each grid point. The solution of the present invention can identify the geology lithological difference more sensitively.

### CROSS-REFERENCE TO RELATED APPLICATIONS

This application claims priority to Chinese Patent Application No. 201410616794.4, filed on Nov. 11, 2014, which is hereby incorporated by reference in its entirety.

### FIELD OF THE INVENTION

The present application relates to the field of geophysical exploration, particularly relates to a method and system for identification of geology lithological difference.

### BACKGROUND

The seismic attribute is a set of characteristics of seismic data, including geometry characteristics, kinematic and dynamic characteristics and statistics characteristics, which can be extracted by mathematic transformation of pre-stack or post-stack seismic data. In seismic interpretation field, it is important to establish the relationship between seismic attributes and geology characteristics (i.e. subsurface structure, lithological characteristics etc.).

In technology history of seismic exploration, people have had experiences to establish the relationship between seismic attributes and subsurface geology characteristics. For example, during the early stages of technology development, seismic events have been used to position target and to map subsurface structure. Although many kinds of attributes have been developed as time goes on, only a few of them with definite physical meaning play an important role for exploration and development of oil and gas. And the resolution of these attributes is not strong enough for their linear theoretical basis.

Nowadays, carbonate reservoir is one of the most important fields of exploration and is a challenge to geophysical technology. The carbonate reservoir with complex genesis, strong heterogeneity and irregular distribution always shows strong nonlinear characteristics on geophysical responses. Therefore, conventional attributes based on linear theory do not have enough resolution on carbonate reservoir characterization. And also, for small differences among carbonates, conventional attributes are too roughly to depict them, which eventually make boundaries of carbonate inner structure unclear.

### SUMMARY

The purpose of the embodiments of the present application is to provide a method and system for identification of geology lithological difference, which can identify the geology lithological difference more sensitively.

In order to solve the above technical problems, the embodiments of the present application provide a method for identification of geology lithological difference, characterized by:
obtaining seismic amplitude data of geology object to be detected;
using seismic amplitude value of each grid point as the initial value of chaos nonlinear iteration equation and then to iterate by the equation, and recording convergence rate of each grid point when the iteration reaches a stable state; and
depicting the lithological difference of the geology object to be detected by the difference of the convergence rate of each grid point.

The embodiments of the present application provide an apparatus for identification of geology lithological difference, comprising:
a seismic amplitude data sampler, which is configured to obtain seismic amplitude data of geology object to be detected;
a processor, which electrically connects to the seismic amplitude data simpler; and which is configured to use a seismic amplitude value of each grid point as the initial value of a chaos nonlinear iteration equation and then to iterate by the equation; and which is configured to record a convergence rate of each grid point when the iteration reaches a stable state; and which is configured to depict the lithological difference of the geology object to be detected by the difference of the convergence rate of each grid point.

In embodiments of the present application, through iterations of seismic amplitude values on each grid point by the chaos nonlinear iteration equation, the difference among seismic amplitude data can be magnified, and subtle differences of lithology can be highlighted. Therefore, both the resolution and the sensitivity of identification are increased effectively.

Nowadays, a carbonate reservoir is one of the most important exploration targets for geologists, and is also a great challenge for the geophysicist. Because carbonate reservoirs with complex genesis, strong heterogeneity and irregular distribution always show strong nonlinear characteristics on geophysical responses, which makes conventional attributes based on linear theory do not have enough resolution on carbonate reservoir characterization. Also, for small differences among carbonate rocks, conventional attributes are too rough to depict them so as to make boundaries of the carbonate inner structure unclear.

In order to solve the geophysical technical problems, the embodiments of the present application provide a nonlinear method for identification of geology lithological difference. This method not only can magnify subtle difference among carbonate rocks, which will make geology boundaries clear, but also can highlight reservoir boundaries, which will make the exploration target stand out effectively. Hence, this method will help geologists and geophysicists quickly get geology lithological distribution, geology boundaries (i.e. fault, strata boundaries etc.) and even reservoir boundaries, which will be beneficial to speed up the explanation process, and to improve the interpretation precision and even to shorten the exploration period. Therefore, this method has certain market prospect in industrial application in the long run.

### FIGURES

In order to more clearly explain the technical solution in the embodiments of the present application or in the prior art, the following is a brief introduction to the figures which need to be used in the description of the embodiments or the prior art. Obviously, the following figures are only some embodiments recorded in the present application. The persons skilled in the art can also obtain other figures based on these figures without creative labor.

FIG. 1 is a flow chart of a method for identification of geology lithological difference;

FIG. 2 is a flow chart of concrete realization of a method for identification of geology lithological difference as provided by the embodiments of the present application;

FIG. 3 is a sketch map of a method for identification of geology lithological difference as provided by the embodiments of the present application;

FIG. 4 is a comparison between the coherence attribute of convergence rate of a method for identification of geology lithological difference as provided by the embodiments of the present application and conventional coherence attribute;

FIG. 5 is a comparison between the standard deviation attribute of convergence rate of a method for identification of geology lithological difference as provided by the embodiments of the present application and a known geology lithological distribution map;

FIG. 6 is a sketch map of a 3D gird of the seismic amplitude data;

FIG. 7 depicts four geology lithological distribution maps showing seismic attributes.

FIG. 8 is a comparison between the convergence rate attribute of a method for identification of geology lithological difference as provided by the embodiments of the present application and conventional coherence attribute.

### DESCRIPTION

In order that the persons skilled in the art better understand the technical solution of the present application, the following text clearly and completely describe the technical solution of the present application in combination with the figures of the embodiments. Obviously, the described embodiments are only a part of embodiments of the present application, not all the embodiments. Based on the embodiments of the present application, other embodiments obtained by the ordinary persons skilled in the art without creative labor shall belong to the protection scope of the present application.

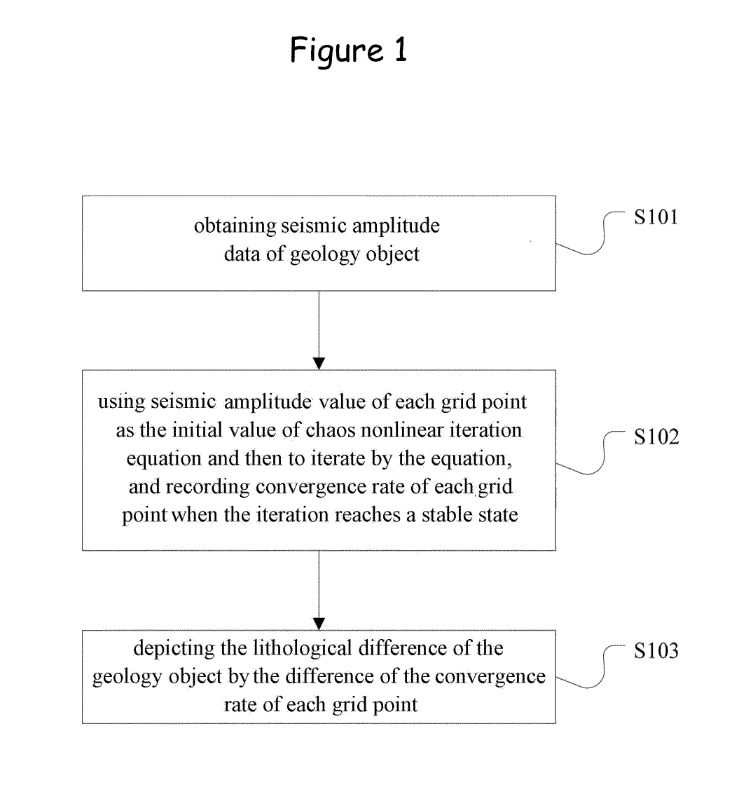

FIG. 1 shows a flow chart of a method for identification of geology lithological difference as provided by the present application, as shown by FIG. 1, the method includes the following steps:

Step S101: obtaining seismic amplitude data of geology object to be detected.

Step S102: using seismic amplitude value of each grid point as the initial value of chaos nonlinear iteration equation and then to iterate by the equation, and recording convergence rate of each grid point when the iteration reaches a stable state.

Step S103: depicting the lithological difference of the geology object to be detected by the difference of the convergence rate of each grid point.

The term “lithological difference” refers to rocks with different physical characteristics, such as sedimentary rocks, metamorphic rocks, and igneous rocks, which are three different rock types of lithology. Rocks having different physical characteristics, as recognized in the field of lithology, can be said to show a lithological difference.

The term “geology object” refers to an oil and gas exploration target, such as reservoirs of sedimentary strata, reservoirs of metamorphic strata, reservoirs of igneous strata, and so on.

In embodiments of the present application, through iterations of seismic amplitude value on each grid point by the chaos nonlinear iteration equation, the difference among seismic amplitude data can be magnified, and the subtle difference of lithology can be highlighted. Therefore, both the resolution and the sensitivity of identification are increased effectively.

The following text is about concrete realization of the method for identification of geology lithological difference in the embodiments of the present application.

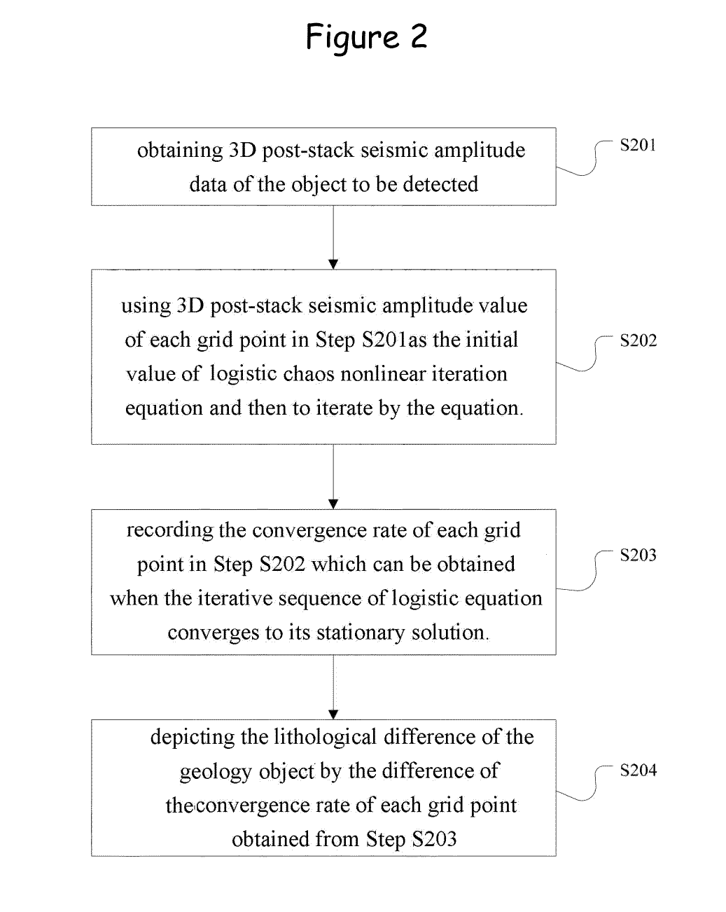

As shown in FIG. 2, in this example, the identification method includes the following steps:

Step S201: to obtain 3D post-stack seismic amplitude data of geology object to be detected, the data structure (or data volume) of seismic amplitude on each grid point is written:)

{A(aᵢ,bⱼ,tₖ)|iₘᵢₙ<i<iₘₐₓ, jₘₐₓ, kₘᵢₙ<k<kₘₐₓ}

wherein, (aᵢ,bⱼ,tₖ) is a coordinate point of a 3D grid, in which aᵢ, a coordinate value of the ith grid point in an inline direction, is a number between a minimum coordinate value aᵢ_{ₘᵢₙ} and a maximum coordinate value aᵢ_{ₘₐₓ}; bⱼ, a coordinate value of the jth grid point in a crossline direction, is a number between a minimum coordinate value bⱼ_{ₘᵢₙ} and a maximum coordinate value bⱼ_{ₘₐₓ}; tₖ, a coordinate value of the kth grid point in a time direction, is a number between a minimum coordinate value tₖ_{ₘᵢₙ} and a maximum coordinate value tₖ_{ₘₐₓ}; A(aᵢ,bⱼ,tₖ) represents a seismic amplitude value of the 3D grid point (aᵢ,bⱼ,tₖ) .

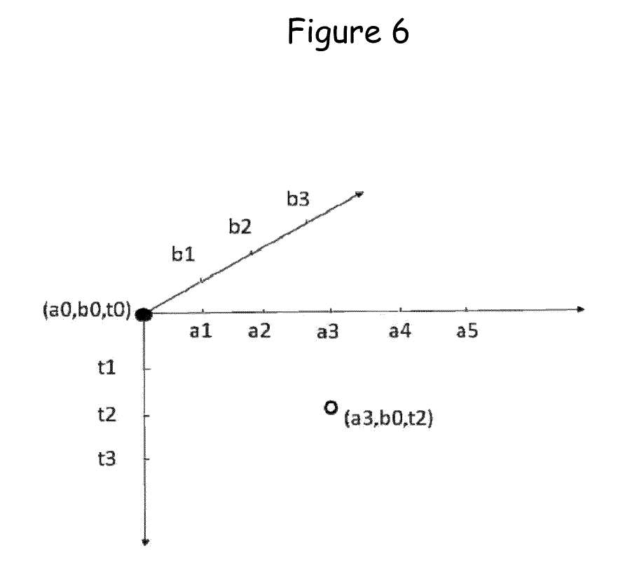

FIG. 6 shows a sketch map of the 3D grid formed by aᵢ, bⱼ and tₖ.

Step S202: using 3D post-stack seismic amplitude value of each grid point in Step S201 as the initial value of logistic chaos nonlinear iteration equation and then to iterate by the equation.

logistic chaos nonlinear iteration equation is:

xₙ₊₁=r*xₙ*(1−xₙ) (Equation 1)

The above equation represents the (n+1)-th iteration, where n is an non-negative integer (n=0,1,2,3 . . . ); xₙ in the right side of the equation stands for the initial value of the (n+1)-th iteration, and xₙ₊₁ in the left side stands for the result of the (n+1)-th iteration.

It is necessary to note that the dynamic behavior of logistic nonlinear iteration equation can be divided into three classes, that is, stationary convergence behavior, period-doubling bifurcation behavior and chaos behavior. And there exists one to one correspondence between these behaviors and intervals of r which is defined as control parameter of the equation to control which behavior shows. In particularly, when r∈[0,3), logistic equation (Equation 1) has stationary solution, and all the iterative sequence {xₙ} produced by the equation will converge to the stationary solution, which means that the difference between the two adjacent iteration values will eventually less than a certain expected value.

More specifically, when r∈[0,3), logistic equation (Equation 1) has stationary solution X* (i.e. when r∈[0,1), x*=0; when r∈[1,3), x*=(r−1)/r), and for every initial value x₀∈[0,1], all the iterative sequence {xₙ} generated by logistic equation will converge to X*, that is to say, for every real number δ>0, there exists a natural number N such that for all n>N, we have ∈xₙ−x*|<δ.

In practice, δ is defined as convergence threshold to stop iteration, and N is defined as a convergence rate. In fact, we can get the convergence rate N by four steps: firstly, choosing control parameter r and getting stationary solution x* of the equation; secondly, conducting iteration by the equation whose initial values are seismic amplitude to generate iterative sequence {xₙ}; thirdly, setting a real number δ>0; finally, substituting each value xₙ of iterative sequence {xₙ} one by one into an inequation |xₙ−x*|<δ to find out the first natural number N which satisfies |x_{N}−x*|<δ and which is just the convergence rate.

As known from the above description, for each amplitude value, we can get its convergence rate N only if we set r and δ. Of course, in practice, we usually set one r and one δ for the whole seismic amplitude data, which will make the convergence rate among different grid points be comparable.

After many experiments, the inventor found that it was logistic chaos nonlinear iteration equation that can make the difference of 3D post-stack seismic amplitude data be magnified effectively. And this kind of difference can be depicted by the difference of the convergence rate which can be obtained when the iterative sequence of logistic equation converges to its stationary solution.

Step S203: recording the convergence rate of each grid point in Step S202 which can be obtained when the iterative sequence of logistic equation converges to its stationary solution.

When r∈[0,3), for every real number x₀∈[0,1], all the iterative sequence {xₙ} which is generated by the logistic equation will converge to stationary solution X* of the equation (i.e. when r∈[0,1), x*=0; when r∈[1,3), x*=(r−1)/r). Therefore we can first set a real number δ>0 as convergence threshold. If there exists a natural number N such that for all n>N, we have |xₙ−x*|<δ, then we will stop the iteration and record N as the convergence rate of x₀.

Thus, the data structure of the convergence rate of each grid point in Step S203 form a 3D convergence rate data volume is, i.e.:

{N_{δ}(aᵢ,bⱼ,tₖ)|iₘᵢₙ<i<iₘₐₓ, jₘᵢₙ<j<jₘₐₓ, kₘᵢₙ<k<kₘₐₓ}

wherein, (aᵢ,bⱼ,tₖ) is a coordinate point of a 3D grid, in which aᵢ, a coordinate value of the ith grid point in an inline direction, is a number between a minimum coordinate value aᵢ_{ₘᵢₙ} and a maximum coordinate value aᵢ_{ₘₐₓ}; bⱼ, a coordinate value of the jth grid point in a crossline direction, is a number between a minimum coordinate value bⱼ_{ₘᵢₙ} and a maximum coordinate value bⱼ_{ₘₐₓ}; tₖ, a coordinate value of the kth grid point in a time direction, is a number between a minimum coordinate value tₖ_{ₘᵢₙ} and a maximum coordinate value tₖ_{ₘₐₓ}; N_{δ}(aᵢ,bⱼ,tₖ) represents a convergence rate value of the 3D grid point (aᵢ,bⱼ,tₖ).

In the stationary solution interval of logistic equation (Equation 1), subtle difference in initial value will generate remarkable difference in the convergence rate of iterative sequence.

Step S204: depicting the lithological difference of the geology object to be detected by the difference of the convergence rate of each grid point obtained from Step S203.

For the geology objects to be detected, the subtle lithological difference always shows as the subtle difference in seismic amplitude. However, it is difficult to directly distinguish the subtle difference in seismic amplitude data. After many experiments, the inventor found that the subtle difference in seismic amplitude data can be effectively magnified by the convergence rate of logistic equation, which makes it possible to depict lithological difference by the difference of the convergence rate of logitistic equation.

It is necessary to note that the choice of control parameter r must fit the characteristics of the geology object to be detected to obtain remarkable difference of the convergence rate of logistic equation. For example, we can try different control parameter r on the seismic amplitude data of the geology object to be detected. Then we can finally find the best parameter r to produce a remarkable difference map of the convergence rate of logistic equation which is used to depict the lithological difference of the geology object to be detected in Step S204.

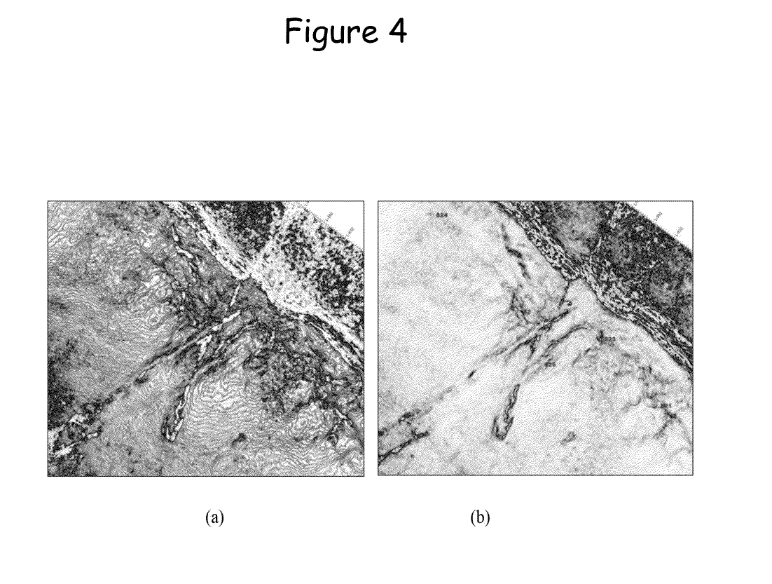

As shown in FIG. 4, FIG. 4a is the coherence attribute of the convergence rate obtained from the embodiments. In fact, we get FIG. 4a by three steps: Firstly, we obtain the seismic amplitude data A(aᵢ,bⱼ,tₖ) on grid point (aᵢ,bⱼ,tₖ),and take A(aᵢ,bⱼ,tₖ) as the initial value of logistic equation to iterate; secondly, we calculate the convergence rate N of each grid point (aᵢ,bⱼ,tₖ) to produce the data volume of convergence rate; finally, we extract coherence attribute from the data volume of convergence rate and obtain FIG. 4a. FIG. 4b is conventional coherence attribute which is directly extracted from seismic amplitude data. From a comparison between FIG. 4a and FIG. 4b, we can see that the geology boundaries and subtle differences are clearer in the result of this embodiment in FIG. 4a, where the lithological difference stand out markedly.

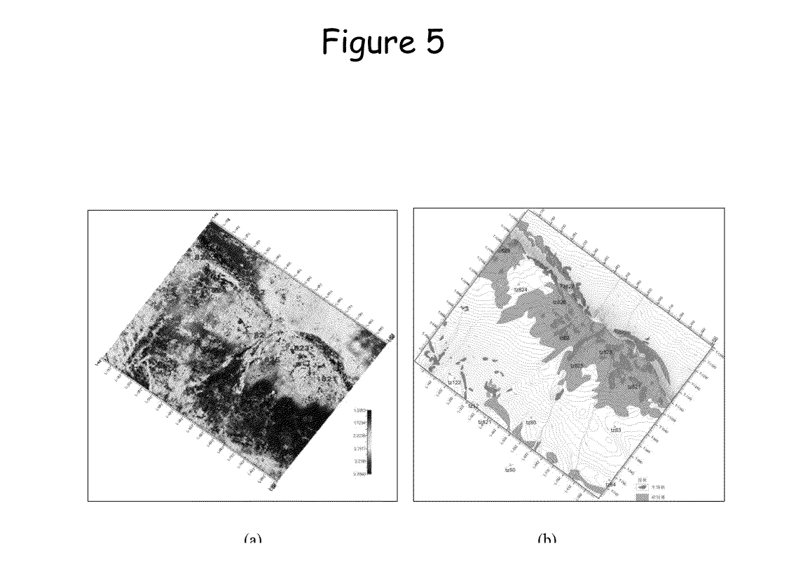

As shown in FIG. 5, FIG. 5a is the standard deviation attribute of the convergence rate obtained from the embodiment. In fact, we get FIG. 5a by three steps: Firstly, we obtain the seismic amplitude data A(aᵢ,bⱼ,tₖ) on grid point (aᵢ,bⱼ,tₖ),and take A(aᵢ,bⱼ,tₖ) as the initial value of logistic equation to iterate; secondly, we calculate the convergence rate N of each grid point (aᵢ,bⱼ,tₖ) to produce the data volume of convergence rate; finally, we extract standard deviation attribute from the data volume of convergence rate and obtain FIG. 5a, In FIG. 5a, we can see that as the convergence rate value goes to a bigger one, the color changes from red to blue. That is to say, the red zones are the areas with fast convergence rate, and the blue zones are the areas with low convergence rate. Therefore, we can directly distinguish lithological difference by the difference of color in FIG. 5a, and we can also clearly identify lithological changes by the changes of color in FIG. 5a. In FIG. 5a, it is necessary to note that there exists one to one correspondence between convergence rate and color, which means that both increase and decrease in the value of convergence rate will lead to color changes. For example, the values of convergence rate 1, 2, 3, 4, 5 are corresponding to the colors red, orange, bright yellow, light blue, dark blue one by one. Hence, the bigger the difference of color is, the bigger the lithological difference becomes. which makes FIG. 5a show both lithological distribution and geology boundaries more clearly. FIG. 5b is the known geology lithological distribution in this research area. From comparison between FIG. 5a and FIG. 5b, we can see that there is highly similarity between the two figures, which means that the lithological distribution in FIG. 5a is highly consistent with the known geology pattern.

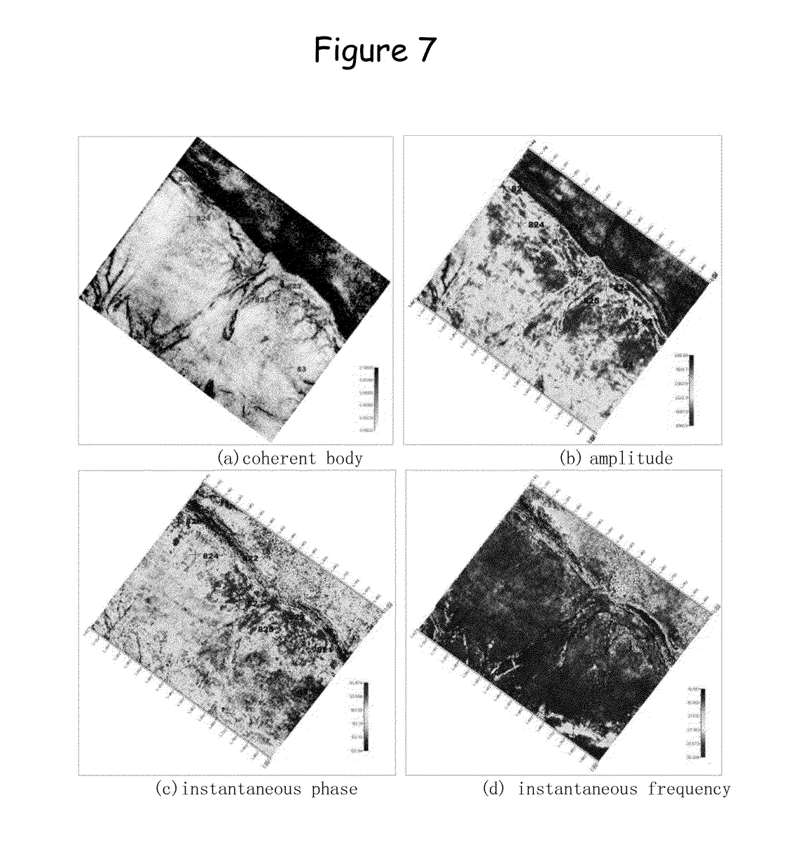

FIG. 7 are four effective conventional seismic attributes in the research area, FIG. 7a is conventional coherence attribute to describe fault distribution; FIG. 7b is amplitude attribute to describe the boundaries between carbonate platform and basin facies; FIG. 7c is instantaneous phase attribute to describe strata boundaries; FIG. 7d is instantaneous frequency attribute to describe fluid distribution. But drilling report in this area shows that all the figures in FIG. 7 cannot effectively depict the distribution of reef-shoal reservoirs. However, from comparison among FIG. 4, FIG. 5 and FIG. 7, we can see that the standard deviation attribute of convergence rate in the embodiments not only can magnify subtle difference in seismic data, but also can effectively highlight the distribution of reef-shoal reservoirs which is highly consistent with the known geology pattern.

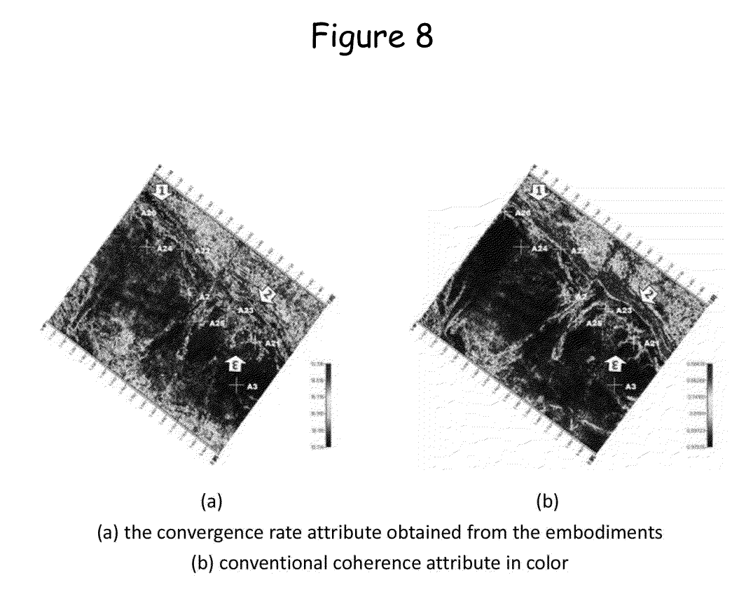

As shown in FIG. 8, FIG. 8a is the convergence rate attribute obtained from the embodiments. In fact, we get FIG. 8a by two steps: Firstly, we obtain the seismic amplitude data A(aᵢ,bⱼ,tₖ) on grid point (aᵢ,bⱼ,tₖ),and take A(aᵢ,bⱼ,tₖ) as the initial value of logistic equation to iterate; secondly, we calculate the convergence rate N of each grid point (aᵢ,bⱼ,tₖ) to produce the data volume of convergence rate and obtain FIG. 8a. FIG. 8b is conventional coherence attribute which is directly extracted from seismic amplitude data. In FIG. 8b, we use color on the conventional coherence attribute to make it be comparable with FIG. 8a. In FIG. 8, we set three observation points where point 1 and point 2 mark the slope edge, while point 3 marks the reservoir area. Through comparison between FIG. 8a and FIG. 8b, we can see that the convergence rate attribute in FIG. 8a has far greater details than the conventional coherence attribute in FIG. 8b. Moreover, in this comparison figure, we can see that the convergence rate attribute in FIG. 8a not only further distinguishes the slope edge in point 1 and point 2 areas , but stands out some new parts of reef-shoal reservoirs especially in point 3 area. And interestingly, slow convergence rate zone in red in FIG. 8a, where all the oil wells A21, A25, A23 are located, can exactly delineate favorable reservoir belt which can be proofed by the drilling report.

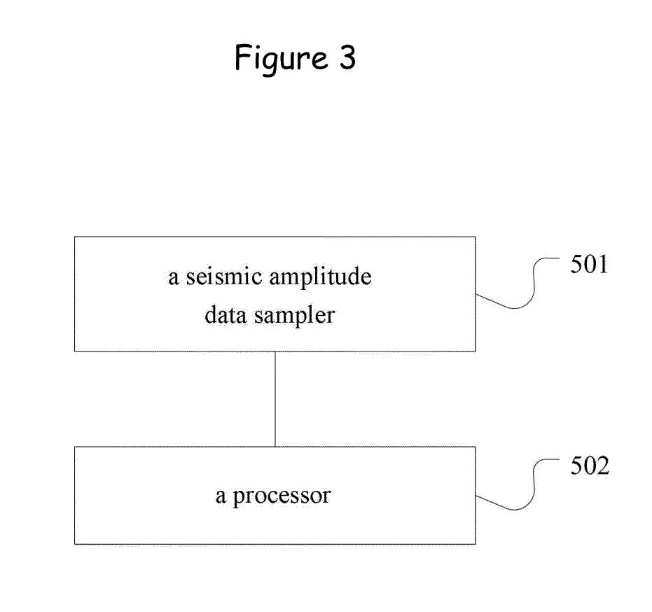

Based on the same inventive concept, the embodiments of the present disclosure also provide an apparatus for identification of geology lithological difference, mentioned as follows: Because of the same principle for identification of geology lithological difference between the apparatus and the method, for the implementation of the apparatus for identification of geology lithological difference, please refer to the implementation of the method for identification of geology lithological difference. The following terms “unit” or “module” are used to describe the software and/or the hardware with certain function. Although the apparatus as described in the following embodiments is better realized by means of software, the realization by means of the hardware or the combination of the software and hardware is possible to conceive. FIG. 3 is a structure diagram of the apparatus for identification of geology lithological difference in the embodiments of the present disclosure. The following text is to explain such structure.

The embodiments of the present disclosure also provide an apparatus for identification of geology lithological difference, as shown in FIG. 3, the apparatus include a seismic amplitude data sampler 501, a processor 502 which electrically connects to the sampler 501.

Where, the seismic amplitude data sampler 501 is configured to obtain the seismic amplitude data of geology object to be detected; the processor 502 is configured to use seismic amplitude value of each grid point as the initial value of a chaos nonlinear iteration equation and then to iterate by the equation, and to record a convergence rate of each grid point when the iteration reaches a stable state, and to depict the lithological difference of the geology object to be detected by the difference of the convergence rate of each grid point.

In embodiments of the present disclosure, through iterations of seismic amplitude value on each grid point by the chaos nonlinear iteration equation, the difference among seismic amplitude data can be magnified, and the subtle difference of lithology can be highlighted. Therefore, both the resolution and the sensitivity of identification are increased effectively.

Wherein, the chaos iteration equation is logistic nonlinear iteration equation, i.e.:

xₙ₊₁=r*xₙ*(1−xₙ) (Equation 2)

the above iteration equation will produce iterative sequence {xₙ}, where, n is an non-negative integer (n=0,1,2,3 . . . ) that represents number of iterations; xₙ is a real number in the interval [0,1] that represents the value of the n-th iteration, x₀ is the first value of the iterative sequence that stands for an initial value of the iteration equation; r is a real number in the interval [0,3) that represents a control parameter of the equation.

in addition, the whole equation represents the (n+1)-th iteration, where xₙ in the right side of the equation stands for an initial value of the (ₙ+1)-th iteration, and xₙ₊₁ in the left side stands for the result of the (ₙ+1)-th iteration.

The dynamic behavior of logistic nonlinear iteration equation can be divided into three classes, that is, stationary convergence behavior, period-doubling bifurcation behavior and chaos behavior. And there exists one to one correspondence between these behaviors and intervals of r which is defined as control parameter of the equation to control which behavior shows. In particularly, when r∈[0,3), logistic equation (Equation 2) has stationary solution, and all the iterative sequence {xₙ} producted by the equation will converge to the stationary solution, which means that the difference between the two adjacent iteration values will eventually less than a certain expected value.

In another embodiment, a software is provided to perform the above embodiments and optimize the technical solution described in the embodiments.

In another embodiment, a storage medium is provided, which stores the above software, includes and is not limited to optical disk, floppy disk, hard disk and erasable memorizers, etc.

Obviously, the persons skilled in the art should understand that each module or step in the above embodiments of the present disclosure can be realized through a common calculating device. They can be centered on a single calculating device or distributed in the network formed by a plurality of calculating device, optionally, they can be realized through executable program codes of a calculating device, however, they can be stored in a storage device and be performed by a calculating device, and in some cases, the shown or described steps can be performed in the sequence different from the sequence here, or they are made into integrated circuit modules, or many modules or steps of them are made into a single integrated circuit module. In this way, the embodiments of the present disclosure are not limited to the combination of any specific hardware and software.

The above embodiments are only preferred ones of the present disclosure and do not limit the present disclosure. For the persons skilled in the art, the embodiments of the present disclosure can have all sorts of variations and changes. Within the spirit and principles of the present disclosure, any amendment, equivalent replacement or improvement, etc. shall be included in the protection scope of the present disclosure.

Although the present invention has been described in considerable detail with reference to certain preferred embodiments, other embodiments are possible. The steps disclosed for the present methods, for example, are not intended to be limiting nor are they intended to indicate that each step is necessarily essential to the method, but instead are exemplary steps only. Therefore, the scope of the appended claims should not be limited to the description of preferred embodiments contained in this disclosure.

Recitation of value ranges herein is merely intended to serve as a shorthand method for referring individually to each separate value falling within the range. Unless otherwise indicated herein, each individual value is incorporated into the specification as if it were individually recited herein. All references cited herein are incorporated by reference in their entirety.

What is claimed is:

1. A method for identification of geology lithological difference,s comprising:
obtaining seismic amplitude data of geology object to be detected;
using seismic amplitude value of each grid point as the initial value of chaos nonlinear iteration equation and then to iterate by the equation, and recording iteration convergence rate of each grid point when the iteration reaches a stable state; and
depicting the lithological difference of the geology object to be detected by the difference of the convergence rate of each grid point.

2. The method of claim 1, wherein the chaos nonlinear iteration equation is:
xₙ₊₁=r*xₙ*(1−xₙ)
the above iteration equation will produce an iterative sequence {xₙ}, where, n is an non-negative integer (n=0,1,2,3 . . . ) that represents number of iterations; xₙ is a real number in the interval [0,1] that represents the value of the n-th iteration, x₀ is the first value of the iterative sequence that stands for an initial value of the iteration equation; r is a real number in the interval [0,3) that represents a control parameter of the equation;
in addition, the above equation represents the (n+1)-th iteration, where xₙ in the right side of the equation stands for an initial value of the (n+1)-th iteration, and xₙ₊₁ in the left side stands for a result of the (n+1)-th iteration.

3. The method of claim 2, wherein when r−[0,3), all the iterative sequence {xₙ} will converge to a stationary solution X* of the equation, i.e., specifically, when r∈[0,1), all the iterative sequence {Xₙ} will converge to the stationary solution x*=0; when r∈[1,3), all the iterative sequence {xₙ} will converge to the stationary solution x*=(r−1)/r. The mentioned convergence process is mathematically described as: when r∈[0,3), for every real number 67 >0, there exists a natural number N such that for all n>N, there is |xₙ−x*|<δ.

4. The method of claim 3, wherein N is defined as a convergence rate.

5. The method of claim 1, wherein a data structure of the seismic amplitude data on each grid point is expressed as:
{A(aᵢ,bⱼ,tₖ)|iₘᵢₙ<i<iₘₐₓ, jₘᵢₙ<j<jₘₐₓ, kₘᵢₙ<k<kₘₐₓ}
wherein, (aᵢ,bⱼ,tₖ) is a coordinate point of a 3D grid, in which aᵢ , a coordinate value of the ith grid point in an inline direction, is a number between a minimum coordinate value aᵢ_{ₘᵢₙ} and a maximum coordinate value aᵢ_{ₘₐₓ}; bⱼ, a coordinate value of the jth grid point in a crossline direction, is a number between a minimum coordinate value bⱼ_{ₘᵢₙ} and a maximum coordinate value bⱼ_{ₘₐₓ}; tₖ, a coordinate value of the kth grid point in a time direction, is a number between a minimum coordinate value tₖ_{ₘᵢₙ} and a maximum coordinate value tₖ_{ₘₐₓ}; A(aᵢ,bⱼ,tₖ) represents a seismic amplitude value of the 3D grid point (aᵢ,bⱼ,tₖ).

6. The method of claim 5, where a data structure of the convergence rate on each grid point is expressed as:
{N_{δ}(aᵢ,bⱼ,tₖ)|iₘᵢₙ<i<iₘₐₓ, jₘᵢₙ<j<jₘₐₓk kₘᵢₙ<k<kₘₐₓ};
wherein, (aᵢ,bⱼ,tₖ) is a coordinate point of a 3D grid, in which aᵢ, a coordinate value of the ith grid point in an inline direction, is a number between a minimum coordinate value aᵢ_{ₘᵢₙ} and a maximum coordinate value aᵢ_{ₘₐₓ}; bⱼ, a coordinate value of the jth grid point in a crossline direction, is a number between a minimum coordinate value bⱼ_{ₘᵢₙ} and a maximum coordinate value bⱼ_{ₘₐₓ}; tₖ, a coordinate value of the kth grid point in a time direction, is a number between a minimum coordinate value tₖ_{ₘᵢₙ} and a maximum coordinate value tₖ_{ₘₐₓ}; N_{δ}(aᵢbⱼ,tₖ) represents a convergence rate value of the 3D grid point (aᵢ,bⱼ,tₖ).

7. The method of claim 6, where the bigger a difference of the convergence rate between any two grid points gets, the bigger the lithological difference becomes, and vice versa.

8. An apparatus for identification of geology lithological differences, comprising:
a seismic amplitude data sampler, which is configured to obtain seismic amplitude data of a geology object to be detected;
a processor, which electrically connects to the seismic amplitude data simpler; and
which is configured to use a seismic amplitude value of each grid point as an initial value of a chaos nonlinear iteration equation and then to iterate by the equation; and which is configured to record a convergence rate of each grid point when the iteration reaches a stable state; and which is configured to depict the lithological difference of the geology object to be detected by a difference of the convergence rate of each grid point.

9. The apparatus of claim 8, where the chaos nonlinear iteration equation is:
xₙ₊₁=r*xₙ*(1−xₙ)
the above iteration equation will produce an iterative sequence {xₙ}, where, n is an non-negative integer (n=0,1,2,3 . . . ) that represents number of iterations; xₙ is a real number in the interval [0,1] that represents a value of the n-th iteration, x₀ is the first value of the iterative sequence that stands for an initial value of the iteration equation; r is a real number in the interval [0,3) that represents a control parameter of the equation;
in addition, the above equation represents the (n+1)-th iteration, where xₙ in the right side of the equation stands for an initial value of the (n+1)-th iteration, and xₙ₊₁ in the left side stands for a result of the (n+1)-th iteration.

10. The apparatus of claim 8, wherein the processor is configured to obtain a convergence rate value, which can be described as: firstly, choosing a control parameter r and getting a stationary solution x* of the equation; secondly, conducting iteration by the equation whose initial values are seismic amplitude to generate an iterative sequence {xₙ}; thirdly, setting a real number δ>0; finally, substituting each value xₙ of the iterative sequence {xₙ} one by one into an inequation xₙ−x*|<δ to find out the first natural number N which satisfies |x_{N}−x*|<δ and which is just the convergence rate.

11. The apparatus of claim 8, wherein a data structure of the seismic amplitude on each grid point obtained by the seismic amplitude data sampler is:
{A(aᵢ,bⱼ,tₖ)|iₘᵢₙ<i<iₘₐₓ, jₘᵢₙ<j<jₘₐₓ, kₘᵢₙ<k<kₘₐₓ}
wherein, (aᵢ,bⱼ,tₖ) is a coordinate point of a 3D grid, in which aᵢ, a coordinate value of the ith grid point in an inline direction, is a number between a minimum coordinate value aᵢ_{ₘᵢₙ} and a maximum coordinate value aᵢ_{ₘₐₓ}; bⱼ, a coordinate value of the jth grid point in a crossline direction, is a number between a minimum coordinate value bⱼ_{ₘᵢₙ} and a maximum coordinate value bⱼ_{ₘₐₓ}; tₖ, a coordinate value of the kth grid point in a time direction, is a number between a minimum coordinate value tₖ_{ₘᵢₙ} and a maximum coordinate value tₖ_{ₘₐₓ}; A(aᵢ,bⱼ,tₖ) represents a seismic amplitude value of the 3D grid point (aᵢ,bⱼ,tₖ).

12. The apparatus of claim 11, where a data structure of the convergence rate on each grid point is:
{N_{δ}(aᵢ,bⱼ,tₖ)|iₘᵢₙ<i<iₘₐₓ, jₘᵢₙ<j<jₘₐₓ, kₘᵢₙ<k<kₘₐₓ}
wherein, (aᵢ,bⱼ,tₖ) is a coordinate point of a 3D grid, in which aᵢ, a coordinate value of the ith grid point in an inline direction, is a number between a minimum coordinate value aᵢ_{ₘᵢₙ} and a maximum coordinate value aᵢ_{ₘₐₓ}; bⱼ, a coordinate value of the jth grid point in a crossline direction, is a number between a minimum coordinate value bⱼ_{ₘᵢₙ} and a maximum coordinate value bⱼ_{ₘₐₓ}; tₖ, a coordinate value of the kth grid point in a time direction, is a number between a minimum coordinate value tₖ_{ₘᵢₙ} and a maximum coordinate value tₖ_{ₘₐₓ}; N_{δ}(aᵢ,bⱼ,tₖ) represents a convergence rate value of the 3D grid point (aᵢ,bⱼ,tₖ).
